(19) United States
(12) Patent Application Publication
(10) Pub. No.: US 2019/0074918 A1
(43) Pub. Date: Mar. 7, 2019

(54) INTRA-FREQUENCY AND INTER-FREQUENCY MEASUREMENT FOR NARROW BAND MACHINE-TYPE COMMUNICATION

(71) Applicant: INTEL IP CORPORATION

(72) Inventors: Rui Huang, Beijing (CN); Yang Tang, San Jose, CA (US); Anatoliy Ioffe, Beaverton, OR (US)

(73) Assignee: INTEL IP CORPORATION, SANTA CLARA, CA (US)

(21) Appl. No.: 15/767,123

(22) PCT Filed: Jul. 1, 2016
(86) PCT No.: PCT/CN16/88121

§ 371 Date: Apr. 9, 2018

(30) Foreign Application Priority Data
Nov. 9, 2015 (CN) PCT/CN16/88121

(51) Int. Cl. H04B 17/382; H04W 36/00; H04B 17/391; H04L 27/26

(52) U.S. Cl. CPC H04B 17/382; H04L 27/2666; H04B 17/391; H04W 36/0088

(57) ABSTRACT

Described is an apparatus of an enhanced Machine Type Communication (eMTC) capable User Equipment (UE) operable to communicate with an eMTC capable Evolved Node-B (eNB) on a wireless network. The apparatus may comprise a first circuitry and a second circuitry. The first circuitry may be operable to initiate an intra-frequency measurement corresponding with an intra-frequency Measurement Gap Length (MGL) of a first duration. The second circuitry may be operable to initiate an inter-frequency measurement corresponding with an inter-frequency MGL of a second duration. The first duration may be shorter than the second duration. The first and second durations may be established by dedicated and separated configuration inputs. The second circuitry may also be operable to schedule a plurality of intra-frequency measurements in accordance with an intra-frequency measurement gap pattern, and may be operable to schedule a plurality of inter-frequency measurements in accordance with an inter-frequency measurement gap pattern.

### CLAIM OF PRIORITY

The present application claims priority under 35 U.S.C. § 119(e) to U.S. Provisional Patent Application Ser. No. 62/252,983 filed Nov. 9, 2015, which is herein incorporated by reference in its entirety.

### BACKGROUND

Various wireless cellular communication systems have been implemented or are being proposed, including a 3rd Generation Partnership Project (3GPP) Universal Mobile Telecommunications System (UMTS), a 3GPP Long-Term Evolution (LTE) system, a 3GPP LTE-Advanced (LTE-A) system, and a 5th Generation wireless/5th Generation mobile networks (5G) system. Next-generation wireless cellular communication systems may provide support for Narrowband (NB) user devices such as Machine-Type Communication (MTC) devices, Internet-of-Things (IoT) devices, or Cellular Internet-of-Things (CIoT) devices.

### BRIEF DESCRIPTION OF THE DRAWINGS

The embodiments of the disclosure will be understood more fully from the detailed description given below and from the accompanying drawings of various embodiments of the disclosure. However, while the drawings are to aid in explanation and understanding, they are only an aid, and should not be taken to limit the disclosure to the specific embodiments depicted therein.

FIG. 1 illustrates a carrier bandwidth on a wireless communication system, in accordance with some embodiments of the disclosure.

FIG. 2 illustrates a portion of a carrier bandwidth on a wireless communication system, in accordance with some embodiments of the disclosure.

FIG. 3 illustrates portions of carrier bandwidths on a wireless communication system, in accordance with some embodiments of the disclosure.

FIG. 4 illustrates a measurement gap pattern, in accordance with some embodiments of the disclosure.

FIG. 5 illustrates a MeasConfig Information Element (IE), in accordance with some embodiments of the disclosure.

FIG. 6 illustrates a MeasGapConfigEMTC IE, in accordance with some embodiments of the disclosure.

FIG. 7 illustrates an Evolved Node B (eNB) and a User Equipment (UE), in accordance with some embodiments of the disclosure.

FIG. 8 illustrates hardware processing circuitries for an enhanced Machine Type Communication (eMTC) UE for intra-frequency measurement and inter-frequency measurement, in accordance with some embodiments of the disclosure.

FIG. 9 illustrates methods for an eMTC UE for intra-frequency measurement and inter-frequency measurement, in accordance with some embodiments of the disclosure.

FIG. 10 illustrates example components of a UE device, in accordance with some embodiments of the disclosure.

### DETAILED DESCRIPTION

Various wireless cellular communication systems have been implemented, including a 3rd Generation Partnership Project (3GPP) Universal Mobile Telecommunications System (UMTS), a 3GPP Long-Term Evolution (LTE) system, and a 3GPP LTE-Advanced (LTE-A) system. Next-generation wireless cellular communication systems are being developed, such as a 5th Generation wireless/5th Generation mobile networks (5G) system. Such next-generation systems may provide support for Narrow Band (NB) user devices such as Machine-Type Communication (MTC) devices, enhanced MTC (eMTC) devices, Internet-of-Things (IoT) devices, or Cellular Internet-of-Things (CIoT) devices.

eMTC-capable User Equipments (UEs) and eMTC-capable Evolved Node-Bs (eNBs) may support narrow band operation, in which the UE might operate merely on a fraction of a full system bandwidth. For example, eMTC UEs may support operation in a narrow band (e.g., 1.4 megahertz (MHz)) within a larger system bandwidth (e.g., 10 MHz). Such narrow band operation may reduce costs for eMTC UEs in comparison with MTC UEs compliant with Release 13 of the 3GPP specification (end date 2016 Mar. 11 (SP-71)) and Category 0 UEs compliant with Release 12 of the 3GPP specification (Frozen 2015 Mar. 13 (SP-67)).

eMTC UEs may also support flexible frequency allocation and frequency hopping for narrow band operation, in which a UE currently tuned to one 6 Physical Resource Block (PRB) sub-band may hop to another 6-PRB sub-band. eMTC UEs may accordingly be tuned to various 6-PRB sub-bands over a system bandwidth, including a fixed, central 6-PRB sub-band of the system bandwidth and other, non-central 6-PRB sub-bands.

Meanwhile, wireless communication systems may in general support handover mechanisms and procedures by which a UE coupled with an eNB of one cell of the system may transition to being coupled with an eNB of another cell of the system. A handover in which a UE remains operating at the same frequencies while moving to another cell may be termed an intra-frequency handover. A handover in which a UE changes to operate at different frequencies while moving to another cell may be termed an inter-frequency handover.

Primary Synchronization Signal (PSS) and Secondary Synchronization Signal (SSS) may be transmitted in a central 6-PRB sub-band of a serving carrier. An eMTC UE may make sue of PSS and SSS transmissions to perform neighbor cell detection (e.g., pursuant to a handover). Accordingly, an eMTC UE that is operating on 6-PRB sub-band outside the central 6-PRB sub-band may be disposed to retuning at least part of a Radio Frequency (RF) chain to the central 6-PRB sub-band to support a handover procedure. Moreover, an eMTC UE may be disposed to retune to the central 6-PRB sub-band not only for inter-frequency handovers, but also for intra-frequency handovers.

Described herein are mechanisms and methods to support intra-frequency measurements and inter-frequency measurements for eMTC-capable UEs (which may be NB MTC UEs). In some embodiments, intra-frequency measurements of a first duration may be initiated, and inter-frequency measurements of a second duration may be initiated. In some embodiments, the first and second durations may be separate and distinctly configurable. For some embodiments, intra-frequency measurements may be scheduled in accordance with an intra-frequency measurement gap pattern, and inter-frequency measurements may be scheduled in accordance with an inter-frequency measurement gap pattern. In some embodiments, Downlink (DL) operation, Uplink (UL) operation, or both may be suspended during intra-frequency measurements. (For purposes of this disclosure, inter-frequency measurement gaps may include inter-frequency measurements and/or inter-Radio-Access-Technology (inter-RAT) measurements.)

In the following description, numerous details are discussed to provide a more thorough explanation of embodiments of the present disclosure. It will be apparent to one skilled in the art, however, that embodiments of the present disclosure may be practiced without these specific details. In other instances, well-known structures and devices are shown in block diagram form, rather than in detail, in order to avoid obscuring embodiments of the present disclosure.

Note that in the corresponding drawings of the embodiments, signals are represented with lines. Some lines may be thicker, to indicate a greater number of constituent signal paths, and/or have arrows at one or more ends, to indicate a direction of information flow. Such indications are not intended to be limiting. Rather, the lines are used in connection with one or more exemplary embodiments to facilitate easier understanding of a circuit or a logical unit. Any represented signal, as dictated by design needs or preferences, may actually comprise one or more signals that may travel in either direction and may be implemented with any suitable type of signal scheme.

Throughout the specification, and in the claims, the term “connected” means a direct electrical, mechanical, or magnetic connection between the things that are connected, without any intermediary devices. The term “coupled” means either a direct electrical, mechanical, or magnetic connection between the things that are connected or an indirect connection through one or more passive or active intermediary devices. The term “circuit” or “module” may refer to one or more passive and/or active components that are arranged to cooperate with one another to provide a desired function. The term “signal” may refer to at least one current signal, voltage signal, magnetic signal, or data/clock signal. The meaning of “a,” “an,” and “the” include plural references. The meaning of “in” includes “in” and “on.”

The terms “substantially,” “close,” “approximately,” “near,” and “about” generally refer to being within +/−10% of a target value. Unless otherwise specified the use of the ordinal adjectives “first,” “second,” and “third,” etc., to describe a common object, merely indicate that different instances of like objects are being referred to, and are not intended to imply that the objects so described must be in a given sequence, either temporally, spatially, in ranking, or in any other manner.

It is to be understood that the terms so used are interchangeable under appropriate circumstances such that the embodiments of the invention described herein are, for example, capable of operation in other orientations than those illustrated or otherwise described herein.

The terms “left,” “right,” “front,” “back,” “top,” “bottom,” “over,” “under,” and the like in the description and in the claims, if any, are used for descriptive purposes and not necessarily for describing permanent relative positions.

For purposes of the embodiments, the transistors in various circuits, modules, and logic blocks are Tunneling FETs (TFETs). Some transistors of various embodiments may comprise metal oxide semiconductor (MOS) transistors, which include drain, source, gate, and bulk terminals. The transistors may also include Tri-Gate and FinFET transistors, Gate All Around Cylindrical Transistors, Square Wire, or Rectangular Ribbon Transistors or other devices implementing transistor functionality like carbon nanotubes or spintronic devices. MOSFET symmetrical source and drain terminals i.e., are identical terminals and are interchangeably used here. A TFET device, on the other hand, has asymmetric Source and Drain terminals. Those skilled in the art will appreciate that other transistors, for example, Bi-polar junction transistors-BJT PNP/NPN, BiCMOS, CMOS, etc., may be used for some transistors without departing from the scope of the disclosure.

For the purposes of the present disclosure, the phrases “A and/or B” and “A or B” mean (A), (B), or (A and B). For the purposes of the present disclosure, the phrase “A, B, and/or C” means (A), (B), (C), (A and B), (A and C), (B and C), or (A, B and C).

In addition, the various elements of combinatorial logic and sequential logic discussed in the present disclosure may pertain both to physical structures (such as AND gates, OR gates, or XOR gates), or to synthesized or otherwise optimized collections of devices implementing the logical structures that are Boolean equivalents of the logic under discussion.

In addition, for purposes of the present disclosure, the term “eNB” may refer to a legacy eNB, an eMTC eNB, a next-generation or 5G eNB, an mmWave eNB, an mmWave small cell, an AP, and/or another base station for a wireless communication system. For purposes of the present disclosure, the term “UE” may refer to a UE, an eMTC UE, a 5G UE, an mmWave UE, an STA, and/or another mobile equipment for a wireless communication system.

Various embodiments of eNBs and/or UEs discussed below may process one or more transmissions of various types. Some processing of a transmission may comprise demodulating, decoding, detecting, parsing, and/or otherwise handling a transmission that has been received. In some embodiments, an eNB or UE processing a transmission may determine or recognize the transmission's type and/or a condition associated with the transmission. For some embodiments, an eNB or UE processing a transmission may act in accordance with the transmission's type, and/or may act conditionally based upon the transmission's type. An eNB or UE processing a transmission may also recognize one or more values or fields of data carried by the transmission. Processing a transmission may comprise moving the transmission through one or more layers of a protocol stack (which may be implemented in, e.g., hardware and/or software-configured elements), such as by moving a transmission that has been received by an eNB or a UE through one or more layers of a protocol stack.

Various embodiments of eNBs and/or UEs discussed below may also generate one or more transmissions of various types. Some generating of a transmission may comprise modulating, encoding, formatting, assembling, and/or otherwise handling a transmission that is to be transmitted. In some embodiments, an eNB or UE generating a transmission may establish the transmission's type and/or a condition associated with the transmission. For some embodiments, an eNB or UE generating a transmission may act in accordance with the transmission's type, and/or may act conditionally based upon the transmission's type. An eNB or UE generating a transmission may also determine one or more values or fields of data carried by the transmission. Generating a transmission may comprise moving the transmission through one or more layers of a protocol stack (which may be implemented in, e.g., hardware and/or software-configured elements), such as by moving a transmission to be sent by an eNB or a UE through one or more layers of a protocol stack.

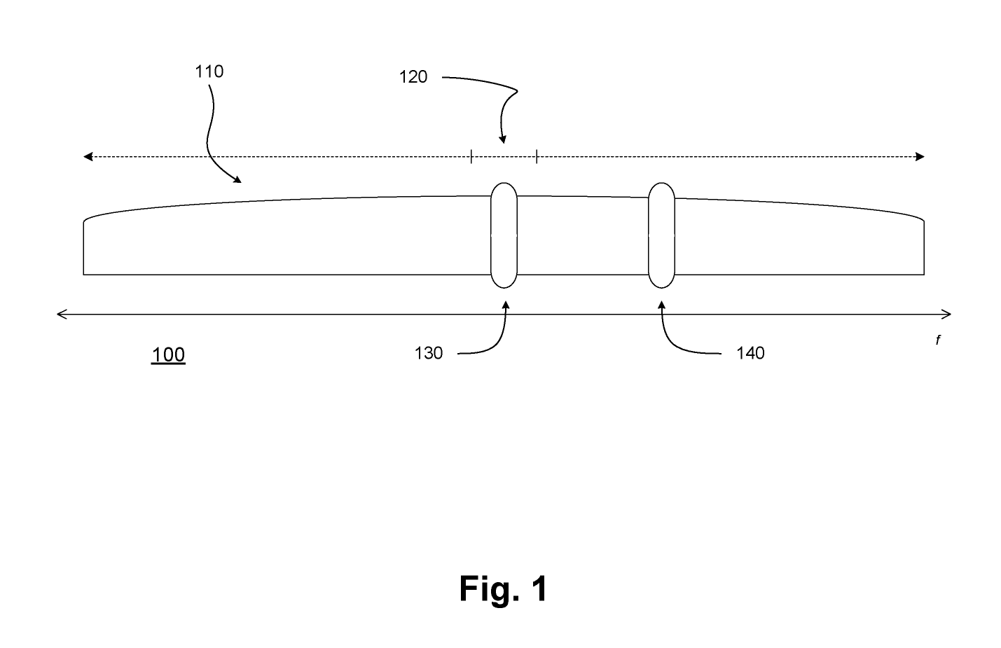

FIG. 1 illustrates a carrier bandwidth on a wireless communication system, in accordance with some embodiments of the disclosure. A frequency spectrum portion 100 may encompass a carrier band 110 with a central region 120. A central sub-band 130 of carrier band 110 may fall within central region 120, while a non-central sub-band 140 of carrier band 110 may fall outside central region 120.

In some embodiments, an eMTC UE may initially be tuned to central sub-band 130, which may be a central 6 PRBs of carrier band 110 within central region 120. The eMTC UE may later be tuned to non-central sub-band 140. For example, the eMTC UE may be tuned to non-central sub-band 140 as a result of frequency hopping within carrier band 110.

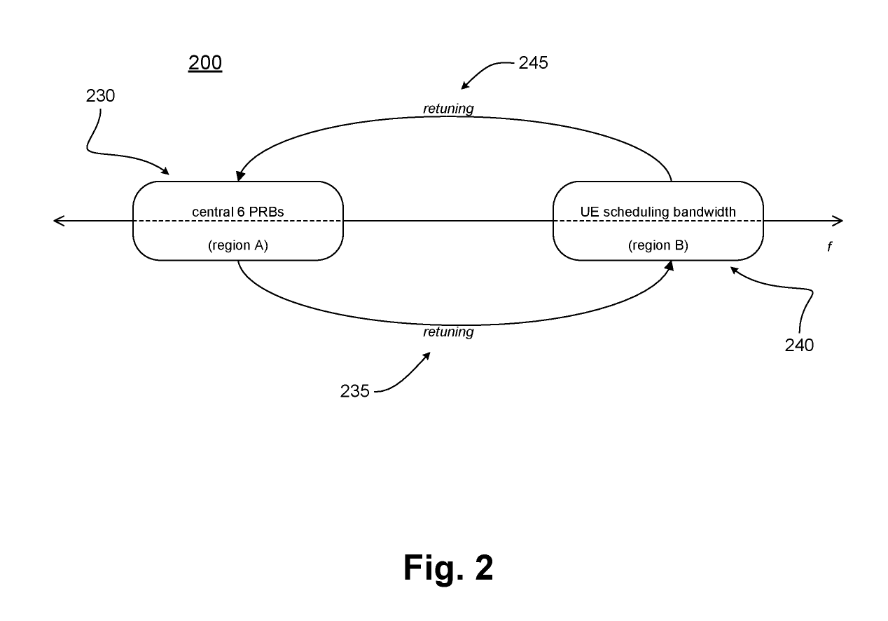

FIG. 2 illustrates a portion of a carrier bandwidth on a wireless communication system, in accordance with some embodiments of the disclosure. A frequency spectrum portion 200 may encompass a carrier band having a central region. A central sub-band 230 of the carrier band may fall within and encompasses a central 6 PRBs of the carrier band, while a non-central sub-band 240 of the carrier band may fall outside the central 6 PRBs of the carrier band.

An eMTC UE may be tuned to the central 6 PRBs of the carrier band. The eMTC UE may then perform a frequency hop to non-central sub-band 240 of the carrier band, and may perform a corresponding retuning 235 to non-central sub-band 240.

Subsequently, while tuned to non-central sub-band 240, the eMTC UE may perform, for example, a handover from its current cell to a new cell. In a legacy LTE system, a UE performing a handover from a sub-band of its current cell to sub-band of the same frequencies in a new cell might not be disposed to perform a retuning. However, an eMTC UE performing a handover may be disposed to making use of PSS and SSS transmissions in the central 6 PRBs of the new cell. Accordingly, when an eMTC UE tuned to non-central sub-band 240 performs a handover from its current cell to a new cell, the eMTC UE may perform a retuning 245 to the central 6 PRBs, which may permit the eMTC UE to advantageously make use of PSS and SSS transmissions.

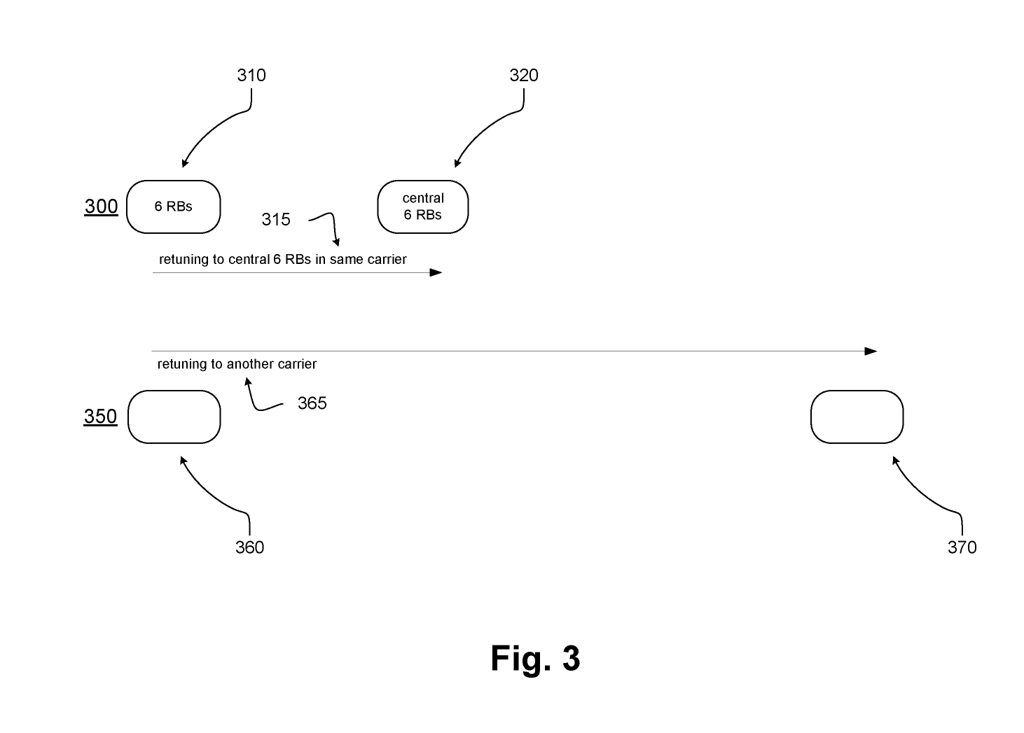

FIG. 3 illustrates portions of carrier bandwidths on a wireless communication system, in accordance with some embodiments of the disclosure. In a scenario 300, an eMTC UE tuned to a sub-band 310 may perform a retuning 315 to a central 6 PRBs 320 in the same carrier. In contrast, in a scenario 350, an eMTC UE tuned to a sub-band 360 may perform a retuning 365 to a sub-band 370 in another carrier.

In some embodiments, retuning 315 may correspond with a measurement gap for intra-frequency measurement, while retuning 365 may correspond with a measurement gap for inter-frequency measurement. In some embodiments, the measurement gaps may be separated in a Time Division Multiplexing (TDM) manner. In some embodiments, the measurement gaps may be separated with different Receiving (Rx) chains.

The retuning time for intra-frequency measurements may be significantly smaller than the retuning time for inter-frequency measurements. This may in turn be related to a much quicker RF re-tuning time for intra-frequency measurements. For example, in some embodiments, an intra-frequency retuning time may extend over as little as 1 Orthogonal Frequency Division Multiplexing (OFDM) symbols, while an inter-frequency measurement may extend over up to 500 microseconds. This may lead to a difference in Measurement Gap Length (MGL) between the intra-frequency and inter-frequency cases. For example, in some embodiments, an intra-frequency MGL may be 5 milliseconds (ms), while an inter-frequency MGL may be 6 ms.

In some embodiments, an eMTC UE may account for these intra-frequency and inter-frequency measurement differences by supporting dedicated and separated intra-frequency measurement gaps and inter-frequency measurement gaps, which may advantageously assist an eMTC UE in reducing an overall overhead associated with measurement gaps of all types. The dedicated and separated intra-frequency and inter-frequency measurement gaps may in some embodiments be configured by various elements of the network coupled to the eMTC UE. In some such embodiments, the network may accordingly have information regarding the gaps to be used for intra-frequency measurements and/or inter-frequency measurements.

In some embodiments, an intra-frequency MGL for eMTC UEs may be substantially the same as, or shorter than, an inter-frequency MGL for legacy LTE systems. For example, an MGL for intra-frequency MGL for an eMTC UE may be 5 ms (in comparison with a 6 ms inter-frequency MGL for legacy LTE systems). For some embodiments, inter-frequency measurement gaps for eMTC UEs may be configured in a manner similar to inter-frequency measurement gaps for legacy LTE systems.

Meanwhile, in various embodiments, an inter-frequency measurement may use an Rx chain, and DL operation may therefore be suspended during the inter-frequency measurement gap. To avoid potential interference with the inter-frequency measurement, UL operation may be likewise suspended. In contrast, DL operation and/or UL operation might not be suspended during an intra-frequency measurement gap. The suspension of DL operation may depend upon network scheduling, and in some embodiments, UL operation might not need to be suspended. For some embodiments, the network's information regarding the dedicated and separated intra-frequency and inter-frequency measurement gaps to be used may allow the network to separately schedule (and/or suspend) DL operation and/or UL operation.

For some embodiments, an intra-frequency Measurement Gap Repetition Period (MGRP) for eMTC UEs may be substantially similar to an inter-frequency MGRP for legacy LTE systems, while in other embodiments an intra-frequency MGRP for eMTC UEs may be different from an inter-frequency MGRP for legacy LTE systems. In some embodiments, an inter-frequency MGRP for eMTC UEs may be substantially similar to an inter-frequency MGRP for legacy LTE systems. Similarities of MGL and/or MGRP between inter-frequency eMTC UEs and legacy LTE networks may advantageously facilitate compatibilities between the eMTC UEs and the legacy LTE networks. For example, similarities of MGL and/or MGRP may advantageously facilitate maintenance of overhead used for measurement gaps.

Table 1 below provides exemplary measurement gap pattern configurations (e.g., for MGL and/or MGRP) that may be supported by an eMTC UE, in the context of measurement gap pattern configurations for legacy LTE systems, such as 3GPP LTE-A systems. Table 1 below may incorporate entries from “Table 8.1.2.1-1: Gap Pattern Configurations supported by the UE” in accordance with (for example) TS 36.133 (European Telecommunications Standards Institute (ETSI) Technical Specification (TS) 136 133 v12.7.0 (2015-06)). Table 1 below may accordingly replace Table 8.1.2.1-1 for eMTC UEs.

TABLE 1
Gap Pattern Configurations supported by the UE

| | | | Minimum | |
|---|---|---|---|---|
| | | | available | |
| | | | time for inter- | |
| | | | frequency | |
| | | Measurement | and inter-RAT | |
| | | Gap | measurements | |
| Gap | Measurement | Repetition | during | |
| Pattern | Gap Length | Period | 480 ms period | Measurement |
| Id | (MGL, ms) | (MGRP, ms) | (Tinter1, ms) | Purpose |
| 0 | 6 | 40 | 60 | Inter-Frequency |
| | | | | EUTRAN FDD |
| | | | | and TDD, |
| | | | | UTRAN FDD, |
| | | | | GERAN, LCR |
| | | | | TDD, HRPD, |
| | | | | CDMA2000 |
| | | | | 1 × Intra |
| | | | | frequency |
| | | | | measurement |
| | | | | gap for eMTC |
| 1 | 6 | 80 | 30 | Inter-Frequency |
| | | | | EUTRAN FDD |
| | | | | and TDD, |
| | | | | UTRAN FDD, |
| | | | | GERAN, LCR |
| | | | | TDD, HRPD, |
| | | | | CDMA2000 |
| | | | | 1 × Intra |
| | | | | frequency |
| | | | | measurement |
| | | | | gap for eMTC |
| 2 | 6 | 160 | — | Inter-Frequency |
| | | | | EUTRAN FDD |
| | | | | and TDD, |
| | | | | UTRAN FDD, |
| | | | | GERAN, LCR |
| | | | | TDD, HRPD, |
| | | | | CDMA2000 |
| | | | | 1 × Intra |
| | | | | frequency |
| | | | | measurement |
| | | | | gap for eMTC |
| 3 | <6 | 40, 80, 160 | — | Intra frequency |
| | | | | measurement |
| | | | | gap for eMTC |

In some embodiments, dedicated and separated measurement gap patterns may be employed to schedule intra-frequency measurements and inter-frequency measurements. For some embodiments, a shared measurement gap pattern may be employed to schedule intra-frequency and inter-frequency measurements. For various embodiments, a distributed measurement gap pattern may also be defined, in which an eMTC UE may perform more frequent retuning operations for intra-frequency measurement for shorter periods of time. Such operations may lead to reduced latency impact to an eMTC UE's performance, in tradeoff with a total time necessary to complete a measurement operation.

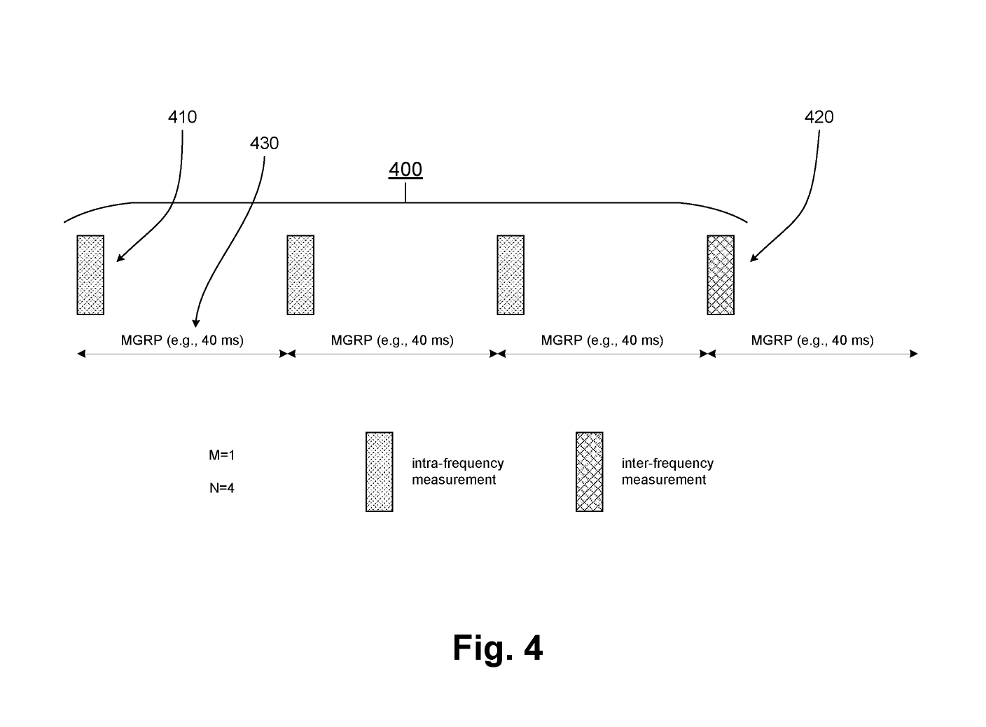

FIG. 4 illustrates a measurement gap pattern, in accordance with some embodiments of the disclosure. A pattern 400 may comprise one or more intra-frequency measurements 410 and one or more inter-frequency measurements 420, which may be separated by a plurality of MGRPs 430. Pattern 400 may comprise a number M of inter-frequency measurements for every N measurements of both intra-frequency and inter-frequency types. A remainder of the N measurements may therefore be intra-frequency measurements. Accordingly, for every N measurements, pattern 400 may comprise a number M of inter-frequency measurements and a number N-M of intra-frequency measurements.

In some embodiments, pattern 400 may be scheduled by the network, which may indicate a pattern to be used for intra-frequency measurements and inter-frequency measurements. Pattern 400 may be scheduled using modifications to a MeasConfig Information Element (IE) as well as a new MeasGapConfigEMTC IE. The network may accordingly establish dedicated and separated measurement gap pattern definitions (and/or MGL, and/or MGRP) for intra-frequency measurements and/or inter-frequency measurements.

In contrast, for various embodiments, a UE may determine and establish dedicated and separated measurement gap pattern definitions (and/or MGL, and/or MGRP) for intra-frequency measurements and/or inter-frequency measurements. The UE may then configure and/or otherwise indicate the dedicated and separated intra-frequency and/or inter-frequency measurement gap pattern definitions (and/or MGL, and/or MGRP) to the network. The patterns may advantageously account for information that the UE may possess regarding how best to share or split resources between intra-frequency measurements and inter-frequency measurements, which may be better than comparable information possessed by the network.

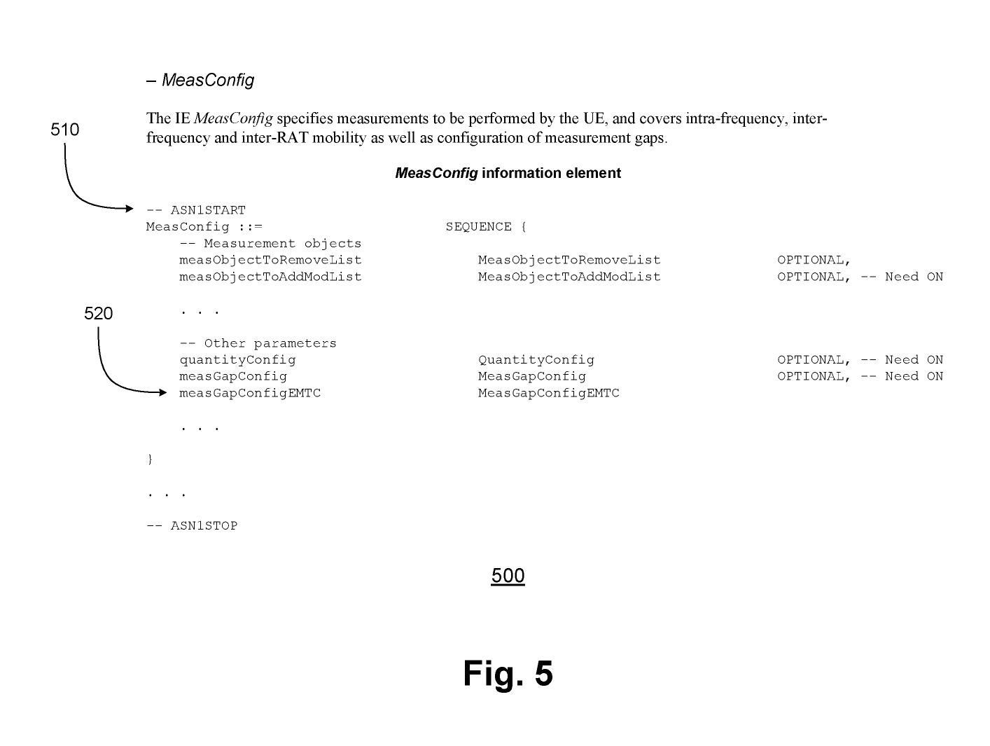

FIG. 5 illustrates a MeasConfig IE, in accordance with some embodiments of the disclosure. A MeasConfig IE 500 may comprise an Abstract Syntax Notation (ASN) MeasConfig definition 510 having a measGapConfig parameter 520. MeasConfig IE 500 may incorporate material from a MeasConfig IE of “6.3.5 Measurement information elements” in accordance with (for example) TS 36.331 (ETSI TS 136 331 v10.7.0 (2012-11)), and portions of MeasConfig IE 500 may replace portions of a MeasConfig IE of “6.3.5 Measurement information elements.” In turn, measGapConfig parameter 520 may correspond to a MeasGapConfigEMTC IE.

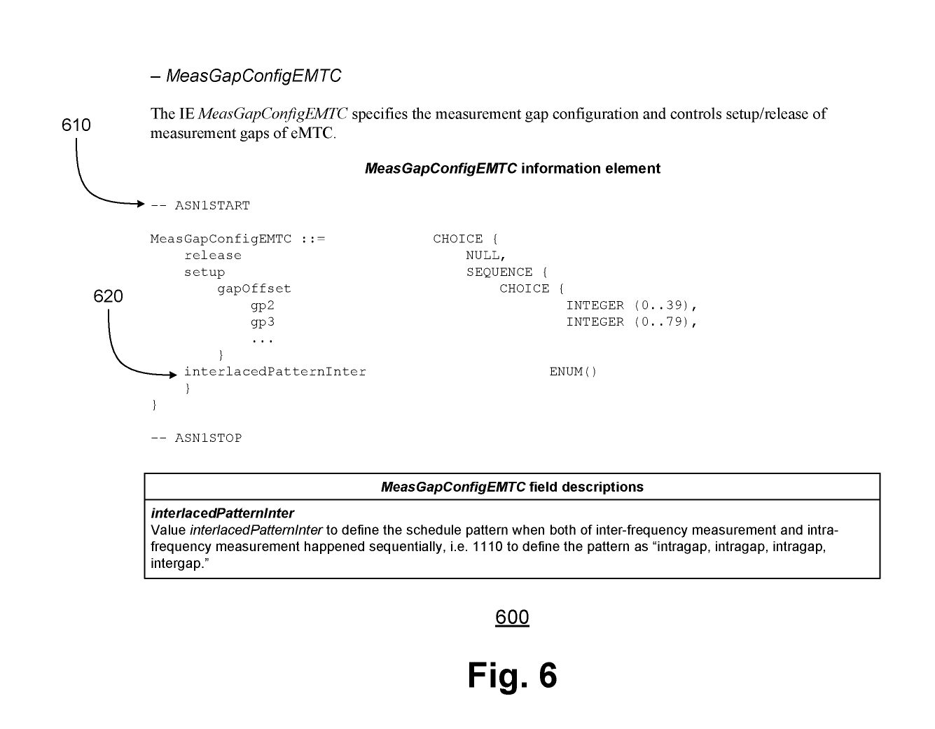

FIG. 6 illustrates a MeasGapConfigEMTC IE, in accordance with some embodiments of the disclosure. A MeasGapConfigEMTC IE 600 may comprise an ASN MeasGapConfigEMTC definition 610. ASN MeasGapConfigEMTC definition 610 may have an interlacedPatternInter value 620. MeasGapConfigEMTC IE 600 may be structurally similar to a MeasGapConfig IE of “6.3.5 Measurement information elements,” in accordance with (for example) TS 36.331 (ETSI TS 136 331 v10.7.0 (2012-11)). In turn, interlacedPatternInter value 620 may define a scheduled pattern of intra-frequency measurements and inter-frequency measurements

For example, with respect to interlacedPatternInter 620, a value of “1110” may correspond with a pattern of “intra-frequency measurement, intra-frequency measurement, intra-frequency measurement, inter-frequency measurement.” Such a pattern may be substantially similar to pattern 400 of intra-frequency and inter-frequency measurements of FIG. 4.

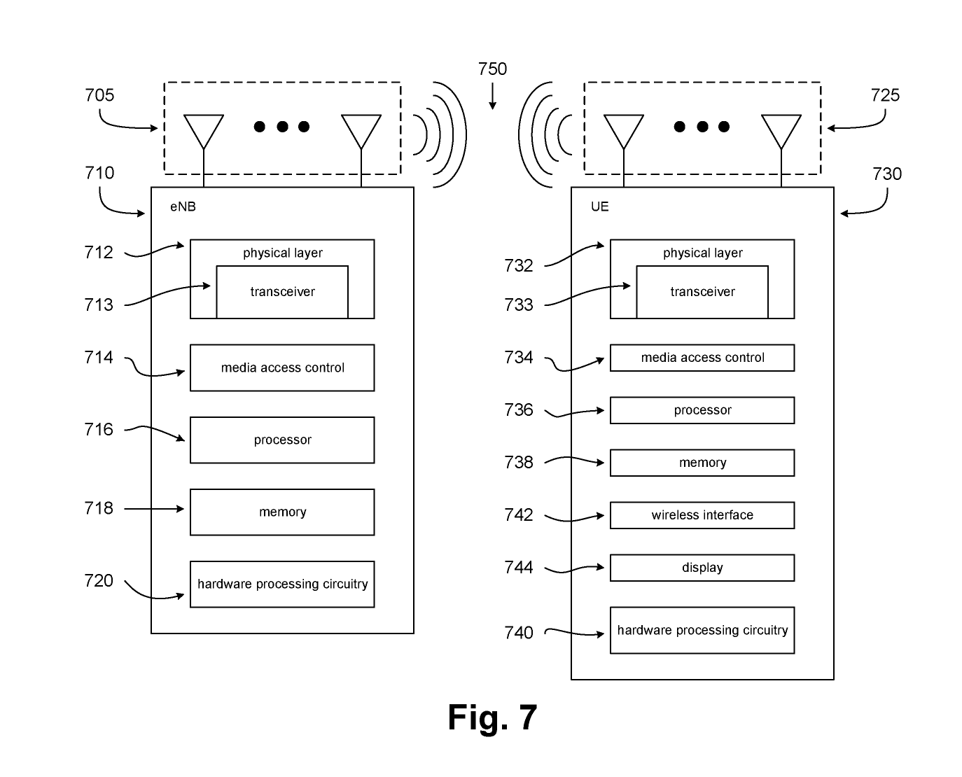

FIG. 7 illustrates an Evolved Node B (eNB) and a User Equipment (UE), in accordance with some embodiments of the disclosure. FIG. 7 includes block diagrams of an eNB 710 and a UE 730 which are operable to co-exist with each other and other elements of an LTE network. High-level, simplified architectures of eNB 710 and UE 730 are described so as not to obscure the embodiments. It should be noted that in some embodiments, eNB 710 may be a stationary non-mobile device.

eNB 710 is coupled to one or more antennas 705, and UE 730 is similarly coupled to one or more antennas 725. However, in some embodiments, eNB 710 may incorporate or comprise antennas 705, and UE 730 in various embodiments may incorporate or comprise antennas 725.

In some embodiments, antennas 705 and/or antennas 725 may comprise one or more directional or omni-directional antennas, including monopole antennas, dipole antennas, loop antennas, patch antennas, microstrip antennas, coplanar wave antennas, or other types of antennas suitable for transmission of RF signals. In some MIMO (multiple-input and multiple output) embodiments, antennas 705 are separated to take advantage of spatial diversity.

eNB 710 and UE 730 are operable to communicate with each other on a network, such as a wireless network. eNB 710 and UE 730 may be in communication with each other over a wireless communication channel 750, which has both a downlink path from eNB 710 to UE 730 and an uplink path from UE 730 to eNB 710.

As illustrated in FIG. 7, in some embodiments, eNB 710 may include a physical layer circuitry 712, a MAC (media access control) circuitry 714, a processor 716, a memory 718, and a hardware processing circuitry 720. A person skilled in the art will appreciate that other components not shown may be used in addition to the components shown to form a complete eNB.

In some embodiments, physical layer circuitry 712 includes a transceiver 713 for providing signals to and from UE 730. Transceiver 713 provides signals to and from UEs or other devices using one or more antennas 705. In some embodiments, MAC circuitry 714 controls access to the wireless medium. Memory 718 may be, or may include, a storage media/medium such as a magnetic storage media (e.g., magnetic tapes or magnetic disks), an optical storage media (e.g., optical discs), an electronic storage media (e.g., conventional hard disk drives, solid-state disk drives, or flash-memory-based storage media), or any tangible storage media or non-transitory storage media. Hardware processing circuitry 720 may comprise logic devices or circuitry to perform various operations. In some embodiments, processor 716 and memory 718 are arranged to perform the operations of hardware processing circuitry 720, such as operations described herein with reference to logic devices and circuitry within eNB 710 and/or hardware processing circuitry 720.

Accordingly, in some embodiments, eNB 710 may be a device comprising an application processor, a memory, one or more antenna ports, and an interface for allowing the application processor to communicate with another device.

As is also illustrated in FIG. 7, in some embodiments, UE 730 may include a physical layer circuitry 732, a MAC circuitry 734, a processor 736, a memory 738, a hardware processing circuitry 740, a wireless interface 742, and a display 744. A person skilled in the art would appreciate that other components not shown may be used in addition to the components shown to form a complete UE.

In some embodiments, physical layer circuitry 732 includes a transceiver 733 for providing signals to and from eNB 710 (as well as other eNBs). Transceiver 733 provides signals to and from eNBs or other devices using one or more antennas 725. In some embodiments, MAC circuitry 734 controls access to the wireless medium. Memory 738 may be, or may include, a storage media/medium such as a magnetic storage media (e.g., magnetic tapes or magnetic disks), an optical storage media (e.g., optical discs), an electronic storage media (e.g., conventional hard disk drives, solid-state disk drives, or flash-memory-based storage media), or any tangible storage media or non-transitory storage media. Wireless interface 742 may be arranged to allow the processor to communicate with another device. Display 744 may provide a visual and/or tactile display for a user to interact with UE 730, such as a touch-screen display. Hardware processing circuitry 740 may comprise logic devices or circuitry to perform various operations. In some embodiments, processor 736 and memory 738 may be arranged to perform the operations of hardware processing circuitry 740, such as operations described herein with reference to logic devices and circuitry within UE 730 and/or hardware processing circuitry 740.

Accordingly, in some embodiments, UE 730 may be a device comprising an application processor, a memory, one or more antennas, a wireless interface for allowing the application processor to communicate with another device, and a touch-screen display.

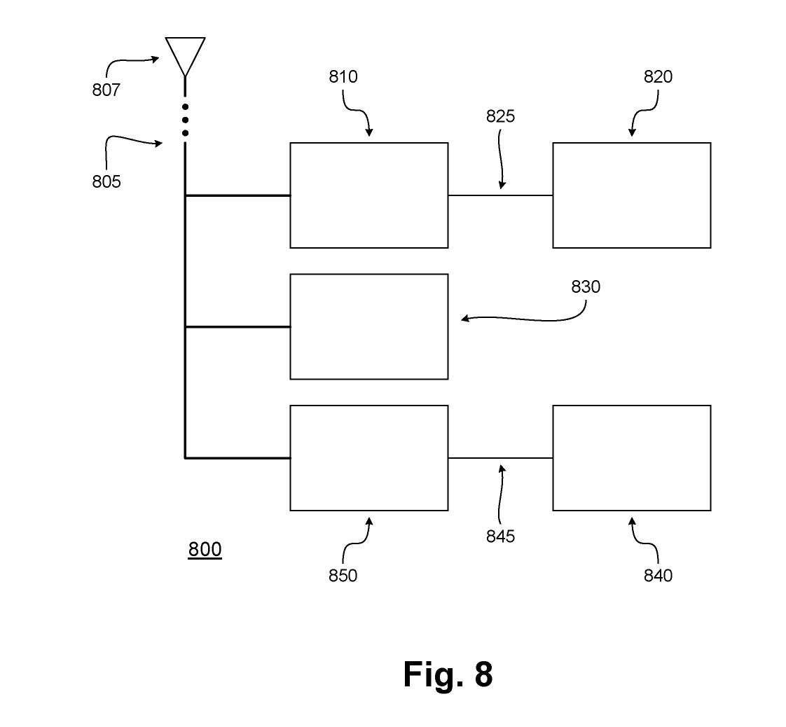

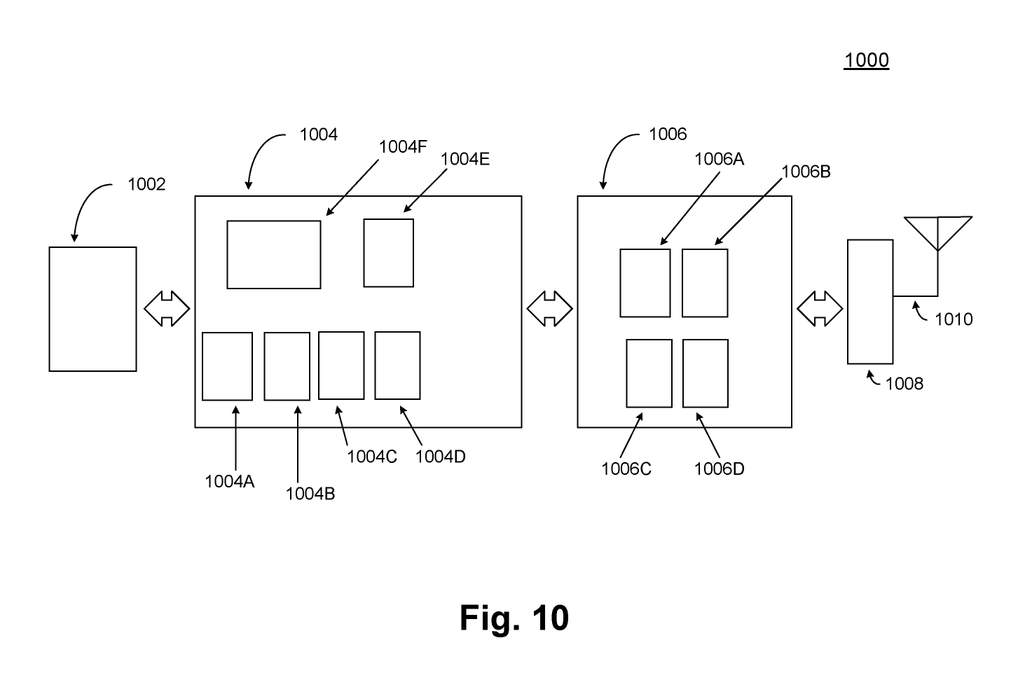

Elements of FIG. 7, and elements of other figures having the same names or reference numbers, can operate or function in the manner described herein with respect to any such figures (although the operation and function of such elements is not limited to such descriptions). For example, FIGS. 8 and 10 also depict embodiments of eNBs, hardware processing circuitry of eNBs, UEs, and/or hardware processing circuitry of UEs, and the embodiments described with respect to FIG. 7 and FIGS. 8 and 10 can operate or function in the manner described herein with respect to any of the figures.

In addition, although eNB 710 and UE 730 are each described as having several separate functional elements, one or more of the functional elements may be combined and may be implemented by combinations of software-configured elements and/or other hardware elements. In some embodiments of this disclosure, the functional elements can refer to one or more processes operating on one or more processing elements. Examples of software and/or hardware configured elements include Digital Signal Processors (DSPs), one or more microprocessors, DSPs, Field-Programmable Gate Arrays (FPGAs), Application Specific Integrated Circuits (ASICs), Radio-Frequency Integrated Circuits (RFICs), and so on.

A UE may include various hardware processing circuitries discussed below (such as hardware processing circuitry 800 of FIG. 8), which may in turn comprise logic devices and/or circuitry operable to perform various operations. For example, with reference to FIG. 7, UE 730 (or various elements or components therein, such as hardware processing circuitry 740, or combinations of elements or components therein) may include part of, or all of, these hardware processing circuitries.

In some embodiments, one or more devices or circuitries within these hardware processing circuitries may be implemented by combinations of software-configured elements and/or other hardware elements. For example, processor 736 (and/or one or more other processors which UE 730 may comprise), memory 738, and/or other elements or components of UE 730 (which may include hardware processing circuitry 740) may be arranged to perform the operations of these hardware processing circuitries, such as operations described herein with reference to devices and circuitry within these hardware processing circuitries. In some embodiments, processor 736 (and/or one or more other processors which UE 730 may comprise) may be a baseband processor.

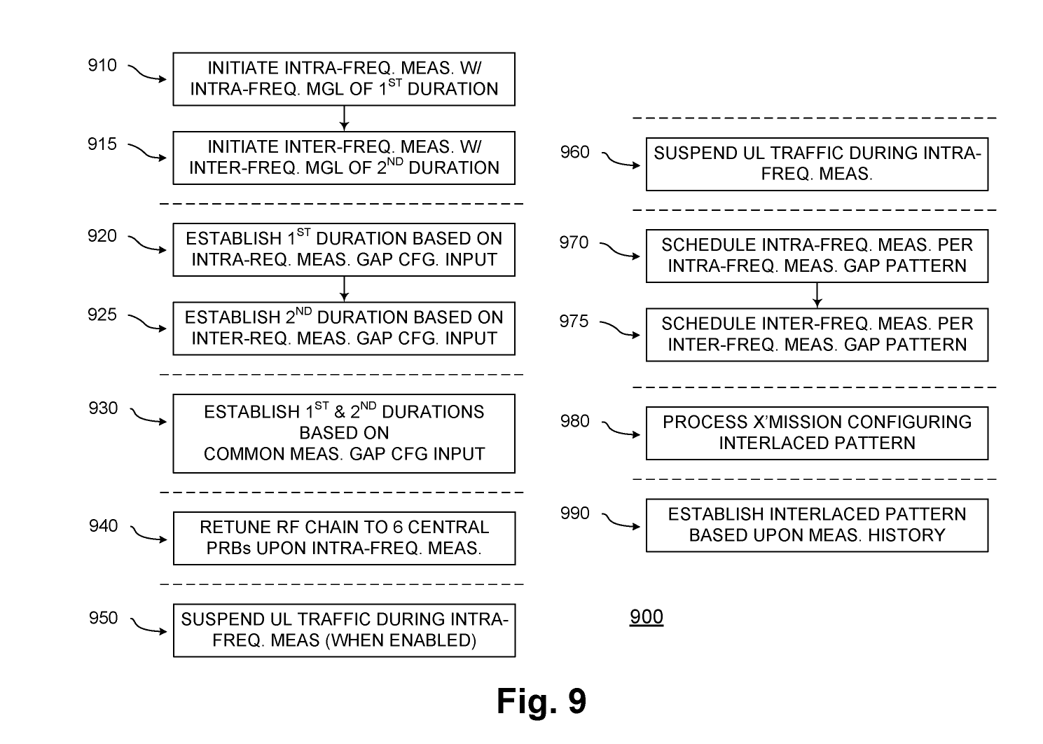

Various methods that may relate to UE 730 and hardware processing circuitry 740 are discussed below. Although the actions in the flowchart 900 with reference to FIG. 9 are shown in a particular order, the order of the actions can be modified. Thus, the illustrated embodiments can be performed in a different order, and some actions may be performed in parallel. Some of the actions and/or operations listed in FIG. 9 are optional in accordance with certain embodiments. The numbering of the actions presented is for the sake of clarity and is not intended to prescribe an order of operations in which the various actions must occur. Additionally, operations from the various flows may be utilized in a variety of combinations.

Moreover, in some embodiments, machine readable storage media may have executable instructions that, when executed, cause UE 730 and/or hardware processing circuitry 740 to perform an operation comprising the methods of FIG. 9. Such machine readable storage media may include any of a variety of storage media, like magnetic storage media (e.g., magnetic tapes or magnetic disks), optical storage media (e.g., optical discs), electronic storage media (e.g., conventional hard disk drives, solid-state disk drives, or flash-memory-based storage media), or any other tangible storage media or non-transitory storage media.

In some embodiments, an apparatus may comprise means for performing various actions and/or operations of the methods of FIG. 9.

FIG. 8 illustrates hardware processing circuitries for an eMTC UE for intra-frequency measurement and inter-frequency measurement, in accordance with some embodiments of the disclosure. An apparatus of UE 730 (or another UE or mobile handset), which may be operable to communicate with one or more eNBs on a wireless network, may comprise hardware processing circuitry 800. In some embodiments, hardware processing circuitry 800 may comprise one or more antenna ports 805 operable to provide various transmissions over a wireless communication channel (such as wireless communication channel 750). Antenna ports 805 may be coupled to one or more antennas 807 (which may be antennas 725). In some embodiments, hardware processing circuitry 800 may incorporate antennas 807, while in other embodiments, hardware processing circuitry 800 may merely be coupled to antennas 807.

Antenna ports 805 and antennas 807 may be operable to provide signals from a UE to a wireless communications channel and/or an eNB, and may be operable to provide signals from an eNB and/or a wireless communications channel to a UE. For example, antenna ports 805 and antennas 807 may be operable to provide transmissions from UE 730 to wireless communication channel 750 (and from there to eNB 710, or to another eNB). Similarly, antennas 807 and antenna ports 805 may be operable to provide transmissions from a wireless communication channel 750 (and beyond that, from eNB 710, or another eNB) to UE 730.

With reference to FIG. 8, hardware processing circuitry 800 may comprise a first circuitry 810, a second circuitry 820, a third circuitry 830, a fourth circuitry 840, and a fifth circuitry 850. First circuitry 810 may be operable to initiate an intra-frequency measurement corresponding with an intra-frequency MGL of a first duration. First circuitry 810 may also be operable to initiate an inter-frequency measurement corresponding with an inter-frequency MGL of a second duration.

In some embodiments, the first duration may be shorter than the second duration. For example, the first duration may be approximately 5 ms and the second duration may be approximately 6 ms. In other embodiments, the first duration may be approximately the same as the second duration. For some embodiments, the first duration and the second duration may be approximately the same as an MGL duration for inter-frequency measurements in accordance with ETSI TS 136 133 v12.7.0 (2015-06).

In some embodiments, second circuitry 820 may be operable to establish the first duration based upon an intra-frequency measurement gap configuration input, and may be operable to establish the second duration based upon an inter-frequency measurement gap configuration input. For some embodiments, second circuitry 820 may be operable to establish the first duration and the second duration are based upon a common measurement gap configuration input. Second circuitry 820 may provide the first duration and/or the second duration to first circuitry 810 via an interface 825.

For some embodiments, third circuitry 830 may be operable to retune at least part of an RF chain to a central 6 PRBs of a serving carrier following the initiation of the intra-frequency measurement. In some embodiments, fourth circuitry 840 may be operable to suspend UL operation and/or DL operation during the intra-frequency measurement when an intra-frequency UL suspension enable input is asserted. For some embodiments, fourth circuitry 840 may be operable to suspend UL operation and DL operation during the intra-frequency measurement.

In some embodiments, first circuitry 810 may be operable to schedule a plurality of intra-frequency measurements in accordance with an intra-frequency measurement gap pattern, and may be operable to schedule a plurality of inter-frequency measurements in accordance with an inter-frequency measurement gap pattern. For some embodiments, the plurality of intra-frequency measurements and the plurality of inter-frequency measurements are portions of an interlaced pattern.

For some embodiments, fifth circuitry 850 may be operable to process a transmission from the eNB configuring the interlaced pattern. In some embodiments, first circuitry 810 may be operable to establish the interlaced pattern based at least in part upon at least one of: an inter-frequency measurement history, and an inter-frequency measurement history. In some embodiments, fourth circuitry 840 may provide a DL operation suspension indicator and/or a UL operation suspension indicator to other circuitries (such as fifth circuitry 850) via an interface 845.

In some embodiments, first circuitry 810, second circuitry 820, third circuitry 830, fourth circuitry 840, and fifth circuitry 850 may be implemented as separate circuitries. In other embodiments, one or more of first circuitry 810, second circuitry 820, third circuitry 830, fourth circuitry 840, and fifth circuitry 850 may be combined and implemented together in a circuitry without altering the essence of the embodiments.

FIG. 9 illustrates methods for an eMTC UE for intra-frequency measurement and inter-frequency measurement, in accordance with some embodiments of the disclosure. A method 900 may comprise an initiation 910 and an initiation 915. Method 900 may also comprise an establishing 920, an establishing 925, an establishing 930, a retuning 940, a suspending 950, a suspending 960, a scheduling 970, a scheduling 975, a processing 980, and/or an establishing 990.

In initiation 910, an intra-frequency measurement corresponding with an intra-frequency MGL of a first duration may be initiated. In initiation 915, an inter-frequency measurement corresponding with an inter-frequency MGL of a second duration may be initiated.

In some embodiments, the first duration may be shorter than the second duration. For example, the first duration may be approximately 5 ms and the second duration may be approximately 6 ms. In other embodiments, the first duration may be approximately the same as the second duration. For some embodiments, the first duration and the second duration may be approximately the same as an MGL duration for inter-frequency measurements in accordance with ETSI TS 136 133 v12.7.0 (2015-06).

In establishing 920, the first duration may be established based upon an intra-frequency measurement gap configuration input. In establishing 925, the second duration may be established based upon an inter-frequency measurement gap configuration input. In establishing 930, the first duration and the second duration may be established based upon a common measurement gap configuration input.

In retuning 940, at least part of an RF chain may be retuned to a central 6 PRBs of a serving carrier following the initiation of the intra-frequency measurement. In suspending 950, UL operation may be suspended during the intra-frequency measurement when an intra-frequency UL suspension enable input is asserted, and/or DL operation may be suspended during the intra-frequency measurement when an intra-frequency DL suspension enable input is asserted. In suspending 960, UL operation and DL operation may be suspended during the intra-frequency measurement.

In scheduling 970, a plurality of intra-frequency measurements may be scheduled in accordance with an intra-frequency measurement gap pattern. In scheduling 975, a plurality of inter-frequency measurements may be scheduled accordance with an inter-frequency measurement gap pattern. In some embodiments, the plurality of intra-frequency measurements and the plurality of inter-frequency measurements may be portions of an interlaced pattern.

In processing 980, a transmission from the eNB configuring the interlaced pattern may be processed. In establishing 990, the interlaced pattern may be established based at least in part upon at least one of: an inter-frequency measurement history, and an inter-frequency measurement history.

FIG. 10 illustrates example components of a UE device, in accordance with some embodiments of the disclosure. In some embodiments, the UE device 1000 may include application circuitry 1002, baseband circuitry 1004, Radio Frequency (RF) circuitry 1006, front-end module (FEM) circuitry 1008, a low-power wake-up receiver (LP-WUR), and one or more antennas 1010, coupled together at least as shown. In some embodiments, the UE device 1000 may include additional elements such as, for example, memory/storage, display, camera, sensor, and/or input/output (I/O) interface.

The application circuitry 1002 may include one or more application processors. For example, the application circuitry 1002 may include circuitry such as, but not limited to, one or more single-core or multi-core processors. The processor(s) may include any combination of general-purpose processors and dedicated processors (e.g., graphics processors, application processors, etc.). The processors may be coupled with and/or may include memory/storage and may be configured to execute instructions stored in the memory/storage to enable various applications and/or operating systems to run on the system.

The baseband circuitry 1004 may include circuitry such as, but not limited to, one or more single-core or multi-core processors. The baseband circuitry 1004 may include one or more baseband processors and/or control logic to process baseband signals received from a receive signal path of the RF circuitry 1006 and to generate baseband signals for a transmit signal path of the RF circuitry 1006. Baseband processing circuitry 1004 may interface with the application circuitry 1002 for generation and processing of the baseband signals and for controlling operations of the RF circuitry 1006. For example, in some embodiments, the baseband circuitry 1004 may include a second generation (2G) baseband processor 1004A, third generation (3G) baseband processor 1004B, fourth generation (4G) baseband processor 1004C, and/or other baseband processor(s) 1004D for other existing generations, generations in development or to be developed in the future (e.g., fifth generation (5G), 6G, etc.). The baseband circuitry 1004 (e.g., one or more of baseband processors 1004A-D) may handle various radio control functions that enable communication with one or more radio networks via the RF circuitry 1006. The radio control functions may include, but are not limited to, signal modulation/demodulation, encoding/decoding, radio frequency shifting, etc. In some embodiments, modulation/demodulation circuitry of the baseband circuitry 1004 may include Fast-Fourier Transform (FFT), precoding, and/or constellation mapping/demapping functionality. In some embodiments, encoding/decoding circuitry of the baseband circuitry 1004 may include convolution, tail-biting convolution, turbo, Viterbi, and/or Low Density Parity Check (LDPC) encoder/decoder functionality. Embodiments of modulation/demodulation and encoder/decoder functionality are not limited to these examples and may include other suitable functionality in other embodiments.

In some embodiments, the baseband circuitry 1004 may include elements of a protocol stack such as, for example, elements of an EUTRAN protocol including, for example, physical (PHY), media access control (MAC), radio link control (RLC), packet data convergence protocol (PDCP), and/or RRC elements. A central processing unit (CPU) 1004E of the baseband circuitry 1004 may be configured to run elements of the protocol stack for signaling of the PHY, MAC, RLC, PDCP and/or RRC layers. In some embodiments, the baseband circuitry may include one or more audio digital signal processor(s) (DSP) 1004F. The audio DSP(s) 1004F may be include elements for compression/decompression and echo cancellation and may include other suitable processing elements in other embodiments. Components of the baseband circuitry may be suitably combined in a single chip, a single chipset, or disposed on a same circuit board in some embodiments. In some embodiments, some or all of the constituent components of the baseband circuitry 1004 and the application circuitry 1002 may be implemented together such as, for example, on a system on a chip (SOC).

In some embodiments, the baseband circuitry 1004 may provide for communication compatible with one or more radio technologies. For example, in some embodiments, the baseband circuitry 1004 may support communication with an evolved universal terrestrial radio access network (EUTRAN) and/or other wireless metropolitan area networks (WMAN), a wireless local area network (WLAN), a wireless personal area network (WPAN). Embodiments in which the baseband circuitry 1004 is configured to support radio communications of more than one wireless protocol may be referred to as multi-mode baseband circuitry.

RF circuitry 1006 may enable communication with wireless networks using modulated electromagnetic radiation through a non-solid medium. In various embodiments, the RF circuitry 1006 may include switches, filters, amplifiers, etc. to facilitate the communication with the wireless network. RF circuitry 1006 may include a receive signal path which may include circuitry to down-convert RF signals received from the FEM circuitry 1008 and provide baseband signals to the baseband circuitry 1004. RF circuitry 1006 may also include a transmit signal path which may include circuitry to up-convert baseband signals provided by the baseband circuitry 1004 and provide RF output signals to the FEM circuitry 1008 for transmission.

In some embodiments, the RF circuitry 1006 may include a receive signal path and a transmit signal path. The receive signal path of the RF circuitry 1006 may include mixer circuitry 1006A, amplifier circuitry 1006B and filter circuitry 1006C. The transmit signal path of the RF circuitry 1006 may include filter circuitry 1006C and mixer circuitry 1006A. RF circuitry 1006 may also include synthesizer circuitry 1006D for synthesizing a frequency for use by the mixer circuitry 1006A of the receive signal path and the transmit signal path. In some embodiments, the mixer circuitry 1006A of the receive signal path may be configured to down-convert RF signals received from the FEM circuitry 1008 based on the synthesized frequency provided by synthesizer circuitry 1006D. The amplifier circuitry 1006B may be configured to amplify the down-converted signals and the filter circuitry 1006C may be a low-pass filter (LPF) or band-pass filter (BPF) configured to remove unwanted signals from the down-converted signals to generate output baseband signals. Output baseband signals may be provided to the baseband circuitry 1004 for further processing. In some embodiments, the output baseband signals may be zero-frequency baseband signals, although this is not a requirement. In some embodiments, mixer circuitry 1006A of the receive signal path may comprise passive mixers, although the scope of the embodiments is not limited in this respect.

In some embodiments, the mixer circuitry 1006A of the transmit signal path may be configured to up-convert input baseband signals based on the synthesized frequency provided by the synthesizer circuitry 1006D to generate RF output signals for the FEM circuitry 1008. The baseband signals may be provided by the baseband circuitry 1004 and may be filtered by filter circuitry 1006C. The filter circuitry 1006C may include a low-pass filter (LPF), although the scope of the embodiments is not limited in this respect.

In some embodiments, the mixer circuitry 1006A of the receive signal path and the mixer circuitry 1006A of the transmit signal path may include two or more mixers and may be arranged for quadrature down-conversion and/or up-conversion respectively. In some embodiments, the mixer circuitry 1006A of the receive signal path and the mixer circuitry 1006A of the transmit signal path may include two or more mixers and may be arranged for image rejection (e.g., Hartley image rejection). In some embodiments, the mixer circuitry 1006A of the receive signal path and the mixer circuitry 1006A may be arranged for direct down-conversion and/or direct up-conversion, respectively. In some embodiments, the mixer circuitry 1006A of the receive signal path and the mixer circuitry 1006A of the transmit signal path may be configured for super-heterodyne operation.

In some embodiments, the output baseband signals and the input baseband signals may be analog baseband signals, although the scope of the embodiments is not limited in this respect. In some alternate embodiments, the output baseband signals and the input baseband signals may be digital baseband signals. In these alternate embodiments, the RF circuitry 1006 may include analog-to-digital converter (ADC) and digital-to-analog converter (DAC) circuitry and the baseband circuitry 1004 may include a digital baseband interface to communicate with the RF circuitry 1006.

In some dual-mode embodiments, a separate radio IC circuitry may be provided for processing signals for each spectrum, although the scope of the embodiments is not limited in this respect.

In some embodiments, the synthesizer circuitry 1006D may be a fractional-N synthesizer or a fractional N/N+1 synthesizer, although the scope of the embodiments is not limited in this respect as other types of frequency synthesizers may be suitable. For example, synthesizer circuitry 1006D may be a delta-sigma synthesizer, a frequency multiplier, or a synthesizer comprising a phase-locked loop with a frequency divider.

The synthesizer circuitry 1006D may be configured to synthesize an output frequency for use by the mixer circuitry 1006A of the RF circuitry 1006 based on a frequency input and a divider control input. In some embodiments, the synthesizer circuitry 1006D may be a fractional N/N+1 synthesizer.

In some embodiments, frequency input may be provided by a voltage controlled oscillator (VCO), although that is not a requirement. Divider control input may be provided by either the baseband circuitry 1004 or the applications processor 1002 depending on the desired output frequency. In some embodiments, a divider control input (e.g., N) may be determined from a look-up table based on a channel indicated by the applications processor 1002.

Synthesizer circuitry 1006D of the RF circuitry 1006 may include a divider, a delay-locked loop (DLL), a multiplexer and a phase accumulator. In some embodiments, the divider may be a dual modulus divider (DMD) and the phase accumulator may be a digital phase accumulator (DPA). In some embodiments, the DMD may be configured to divide the input signal by either N or N+1 (e.g., based on a carry out) to provide a fractional division ratio. In some example embodiments, the DLL may include a set of cascaded, tunable, delay elements, a phase detector, a charge pump and a D-type flip-flop. In these embodiments, the delay elements may be configured to break a VCO period up into Nd equal packets of phase, where Nd is the number of delay elements in the delay line. In this way, the DLL provides negative feedback to help ensure that the total delay through the delay line is one VCO cycle.

In some embodiments, synthesizer circuitry 1006D may be configured to generate a carrier frequency as the output frequency, while in other embodiments, the output frequency may be a multiple of the carrier frequency (e.g., twice the carrier frequency, four times the carrier frequency) and used in conjunction with quadrature generator and divider circuitry to generate multiple signals at the carrier frequency with multiple different phases with respect to each other. In some embodiments, the output frequency may be a LO frequency (fLO). In some embodiments, the RF circuitry 1006 may include an IQ/polar converter.

FEM circuitry 1008 may include a receive signal path which may include circuitry configured to operate on RF signals received from one or more antennas 1010, amplify the received signals and provide the amplified versions of the received signals to the RF circuitry 1006 for further processing. FEM circuitry 1008 may also include a transmit signal path which may include circuitry configured to amplify signals for transmission provided by the RF circuitry 1006 for transmission by one or more of the one or more antennas 1010.

In some embodiments, the FEM circuitry 1008 may include a TX/RX switch to switch between transmit mode and receive mode operation. The FEM circuitry may include a receive signal path and a transmit signal path. The receive signal path of the FEM circuitry may include a low-noise amplifier (LNA) to amplify received RF signals and provide the amplified received RF signals as an output (e.g., to the RF circuitry 1006). The transmit signal path of the FEM circuitry 1008 may include a power amplifier (PA) to amplify input RF signals (e.g., provided by RF circuitry 1006), and one or more filters to generate RF signals for subsequent transmission (e.g., by one or more of the one or more antennas 1010.

In some embodiments, the UE 1000 comprises a plurality of power saving mechanisms. If the UE 1000 is in an RRC_Connected state, where it is still connected to the eNB as it expects to receive traffic shortly, then it may enter a state known as Discontinuous Reception Mode (DRX) after a period of inactivity. During this state, the device may power down for brief intervals of time and thus save power.

If there is no data traffic activity for an extended period of time, then the UE 1000 may transition off to an RRC_Idle state, where it disconnects from the network and does not perform operations such as channel quality feedback, handover, etc. The UE 1000 goes into a very low power state and it performs paging where again it periodically wakes up to listen to the network and then powers down again. Since the device might not receive data in this state, in order to receive data, it should transition back to RRC_Connected state.

An additional power saving mode may allow a device to be unavailable to the network for periods longer than a paging interval (ranging from seconds to a few hours). During this time, the device is totally unreachable to the network and may power down completely. Any data sent during this time incurs a large delay and it is assumed the delay is acceptable.

Reference in the specification to “an embodiment,” “one embodiment,” “some embodiments,” or “other embodiments” means that a particular feature, structure, or characteristic described in connection with the embodiments is included in at least some embodiments, but not necessarily all embodiments. The various appearances of “an embodiment,” “one embodiment,” or “some embodiments” are not necessarily all referring to the same embodiments. If the specification states a component, feature, structure, or characteristic “may,” “might,” or “could” be included, that particular component, feature, structure, or characteristic is not required to be included. If the specification or claim refers to “a” or “an” element, that does not mean there is only one of the elements. If the specification or claims refer to “an additional” element, that does not preclude there being more than one of the additional element.

Furthermore, the particular features, structures, functions, or characteristics may be combined in any suitable manner in one or more embodiments. For example, a first embodiment may be combined with a second embodiment anywhere the particular features, structures, functions, or characteristics associated with the two embodiments are not mutually exclusive.

While the disclosure has been described in conjunction with specific embodiments thereof, many alternatives, modifications and variations of such embodiments will be apparent to those of ordinary skill in the art in light of the foregoing description. For example, other memory architectures e.g., Dynamic RAM (DRAM) may use the embodiments discussed. The embodiments of the disclosure are intended to embrace all such alternatives, modifications, and variations as to fall within the broad scope of the appended claims.

In addition, well known power/ground connections to integrated circuit (IC) chips and other components may or may not be shown within the presented figures, for simplicity of illustration and discussion, and so as not to obscure the disclosure. Further, arrangements may be shown in block diagram form in order to avoid obscuring the disclosure, and also in view of the fact that specifics with respect to implementation of such block diagram arrangements are highly dependent upon the platform within which the present disclosure is to be implemented (i.e., such specifics should be well within purview of one skilled in the art). Where specific details (e.g., circuits) are set forth in order to describe example embodiments of the disclosure, it should be apparent to one skilled in the art that the disclosure can be practiced without, or with variation of, these specific details. The description is thus to be regarded as illustrative instead of limiting.

The following examples pertain to further embodiments. Specifics in the examples may be used anywhere in one or more embodiments. All optional features of the apparatus described herein may also be implemented with respect to a method or process.

Example 1 provides an apparatus of an enhanced Machine Type Communication (eMTC) capable User Equipment (UE) operable to communicate with an eMTC capable Evolved Node B (eNB) on a wireless network, comprising: one or more processors to: initiate an intra-frequency measurement corresponding with an intra-frequency Measurement Gap Length (MGL) of a first duration; and initiate an inter-frequency measurement corresponding with an inter-frequency MGL of a second duration retune at least part of a Radio Frequency (RF) chain to a central 6 Physical Resource Blocks (PRBs) of a serving carrier following the initiation of the intra-frequency measurement.

In example 2, the apparatus of example 1, wherein the one or more processors are further to: establish the first duration based upon an intra-frequency measurement gap configuration input; and establish the second duration based upon an inter-frequency measurement gap configuration input.

In example 3, the apparatus of example 1, wherein the one or more processors are further to: establish the first duration and the second duration are based upon a common measurement gap configuration input.

In example 4, the apparatus of any of examples 1 through 3, wherein the one or more processors are further to: suspend Uplink (UL) operation during the intra-frequency measurement when an intra-frequency UL suspension enable input is asserted.

In example 5, the apparatus of any of examples 1 through 4, wherein the one or more processors are further to: suspend Downlink (DL) operation during the intra-frequency measurement when an intra-frequency DL suspension enable input is asserted.

In example 6, the apparatus of any of examples 1 through 5, wherein the one or more processors are further to: suspend UL operation and Downlink (DL) operation during the intra-frequency measurement.

In example 7, the apparatus of any of examples 1 through 6, wherein the first duration is shorter than the second duration.

In example 8, the apparatus of any of examples 1 through 7, wherein the first duration is approximately 5 milliseconds (ms) and the second duration is approximately 6 ms.

In example 9, the apparatus of any of examples 1 through 6, wherein the first duration is approximately the same as the second duration.

In example 10, the apparatus of example 9, wherein the first duration and the second duration are approximately the same as an MGL duration for inter-frequency measurements in accordance with European Telecommunications Standards Institute (ETSI) Technical Specification (TS) 136 133 v12.7.0 (2015-06).

In example 11, the apparatus of any of examples 1 through 10, wherein the one or more processors are further to: schedule a plurality of intra-frequency measurements in accordance with an intra-frequency measurement gap pattern; and schedule a plurality of inter-frequency measurements in accordance with an inter-frequency measurement gap pattern.

In example 12, the apparatus of example 11, wherein the plurality of intra-frequency measurements and the plurality of inter-frequency measurements are portions of an interlaced pattern.

In example 13, the apparatus of example 12, wherein the one or more processors are further to: process a transmission from the eNB configuring the interlaced pattern.

In example 14, the apparatus of example 12, wherein the one or more processors are further to: establish the interlaced pattern based at least in part upon at least one of: an inter-frequency measurement history, and an inter-frequency measurement history.

Example 15 provides an enhanced Machine Type Communication (eMTC) capable User Equipment (UE) device comprising an application processor, a memory, one or more antennas, a wireless interface for allowing the application processor to communicate with another device, and a touch-screen display, the UE device including the apparatus of any of examples 1 through 14.

Example 16 provides a method comprising: initiating an intra-frequency measurement corresponding with an intra-frequency Measurement Gap Length (MGL) of a first duration; initiating an inter-frequency measurement corresponding with an inter-frequency MGL of a second duration; establishing the first duration based upon an intra-frequency measurement gap configuration input; and establishing the second duration based upon an inter-frequency measurement gap configuration input.

In example 17, the method of example 16, comprising: establishing the first duration and the second duration are based upon a common measurement gap configuration input.

In example 18, the method of either of examples 16 or 17, comprising: retuning at least part of a Radio Frequency (RF) chain to a central 6 Physical Resource Blocks (PRBs) of a serving carrier following the initiation of the intra-frequency measurement.

In example 19, the method of any of examples 16 through 18, comprising: suspending Uplink (UL) operation during the intra-frequency measurement when an intra-frequency UL suspension enable input is asserted.

In example 20, the method of any of examples 16 through 19, comprising: suspending Downlink (DL) operation during the intra-frequency measurement when an intra-frequency DL suspension enable input is asserted.

In example 21, the method of any of examples 16 through 20, comprising: suspending UL operation and Downlink (DL) operation during the intra-frequency measurement.

In example 22, the method of any of examples 16 through 21, wherein the first duration is shorter than the second duration.

In example 23, the method of any of examples 16 through 22, wherein the first duration is approximately 5 milliseconds (ms) and the second duration is approximately 6 ms.

In example 24, the method of any of examples 16 through 21, wherein the first duration is approximately the same as the second duration.

In example 25, the method of example 24, wherein the first duration and the second duration are approximately the same as an MGL duration for inter-frequency measurements in accordance with European Telecommunications Standards Institute (ETSI) Technical Specification (TS) 136 133 v12.7.0 (2015-06).

In example 26, the method of any of examples 16 through 25, comprising: scheduling a plurality of intra-frequency measurements in accordance with an intra-frequency measurement gap pattern; and scheduling a plurality of inter-frequency measurements in accordance with an inter-frequency measurement gap pattern.

In example 27, the method of example 26, wherein the plurality of intra-frequency measurements and the plurality of inter-frequency measurements are portions of an interlaced pattern.

In example 28, the method of example 27, comprising: processing a transmission from the eNB configuring the interlaced pattern.

In example 29, the method of example 27, comprising: establishing the interlaced pattern based at least in part upon at least one of: an inter-frequency measurement history, and an inter-frequency measurement history.

Example 30 provides machine readable storage media having machine executable instructions stored thereon that, when executed, cause one or more processors to perform a method according to any of any of examples 16 through 29.

Example 31 provides an apparatus of an enhanced Machine Type Communication (eMTC) capable User Equipment (UE) operable to communicate with an eMTC capable Evolved Node B (eNB) on a wireless network, comprising: means for initiating an intra-frequency measurement corresponding with an intra-frequency Measurement Gap Length (MGL) of a first duration; means for initiating an inter-frequency measurement corresponding with an inter-frequency MGL of a second duration; means for establishing the first duration based upon an intra-frequency measurement gap configuration input; and means for establishing the second duration based upon an inter-frequency measurement gap configuration input.

In example 32, the apparatus of example 31, comprising: means for establishing the first duration and the second duration are based upon a common measurement gap configuration input.

In example 33, the apparatus of either of examples 31 or 32, comprising: means for retuning at least part of a Radio Frequency (RF) chain to a central 6 Physical Resource Blocks (PRBs) of a serving carrier following the initiation of the intra-frequency measurement.

In example 34, the apparatus of any of examples 31 through 33, comprising: means for suspending Uplink (UL) operation during the intra-frequency measurement when an intra-frequency UL suspension enable input is asserted.

In example 35, the apparatus of any of examples 31 through 34, comprising: means for suspending Downlink (DL) operation during the intra-frequency measurement when an intra-frequency DL suspension enable input is asserted.

In example 36, the apparatus of any of examples 31 through 35, comprising: means for suspending UL operation and Downlink (DL) operation during the intra-frequency measurement.

In example 37, the apparatus of any of examples 31 through 36, wherein the first duration is shorter than the second duration.

In example 38, the apparatus of any of examples 31 through 37, wherein the first duration is approximately 5 milliseconds (ms) and the second duration is approximately 6 ms.

In example 39, the apparatus of any of examples 31 through 36, wherein the first duration is approximately the same as the second duration.

In example 40, the apparatus of example 39, wherein the first duration and the second duration are approximately the same as an MGL duration for inter-frequency measurements in accordance with European Telecommunications Standards Institute (ETSI) Technical Specification (TS) 136 133 v12.7.0 (2015-06).

In example 41, the apparatus of any of examples 31 through 40, comprising: means for scheduling a plurality of intra-frequency measurements in accordance with an intra-frequency measurement gap pattern; and means for scheduling a plurality of inter-frequency measurements in accordance with an inter-frequency measurement gap pattern.

In example 42, the apparatus of example 41, wherein the plurality of intra-frequency measurements and the plurality of inter-frequency measurements are portions of an interlaced pattern.

In example 43, the apparatus of example 42, comprising: means for processing a transmission from the eNB configuring the interlaced pattern.

In example 44, the apparatus of example 42, comprising: means for establishing the interlaced pattern based at least in part upon at least one of: an inter-frequency measurement history, and an inter-frequency measurement history.

Example 45 provides machine readable storage media having machine executable instructions that, when executed, cause one or more processors of an enhanced Machine Type Communication (eMTC) capable User Equipment (UE) to perform an operation comprising: initiate an intra-frequency measurement corresponding with an intra-frequency Measurement Gap Length (MGL) of a first duration; initiate an inter-frequency measurement corresponding with an inter-frequency MGL of a second duration; establish the first duration based upon an intra-frequency measurement gap configuration input; and establish the second duration based upon an inter-frequency measurement gap configuration input.

In example 46, the machine readable storage media of example 45, the operation comprising: establish the first duration and the second duration are based upon a common measurement gap configuration input.

In example 47, the machine readable storage media of either of examples 45 or 46, the operation comprising: retune at least part of a Radio Frequency (RF) chain to a central 6 Physical Resource Blocks (PRBs) of a serving carrier following the initiation of the intra-frequency measurement.

In example 48, the machine readable storage media of any of examples 45 through 47, the operation comprising: suspend Uplink (UL) operation during the intra-frequency measurement when an intra-frequency UL suspension enable input is asserted.

In example 49, the machine readable storage media of any of examples 45 through 48, the operation comprising: suspend Downlink (DL) operation during the intra-frequency measurement when an intra-frequency DL suspension enable input is asserted.

In example 50, the machine readable storage media of any of examples 45 through 49, the operation comprising: suspend UL operation and Downlink (DL) operation during the intra-frequency measurement.

In example 51, the machine readable storage media of any of examples 45 through 50, wherein the first duration is shorter than the second duration.

In example 52, the machine readable storage media of any of examples 45 through 51, wherein the first duration is approximately 5 milliseconds (ms) and the second duration is approximately 6 ms.

In example 53, the machine readable storage media of any of examples 45 through 50, wherein the first duration is approximately the same as the second duration.

In example 54, the machine readable storage media of example 53, wherein the first duration and the second duration are approximately the same as an MGL duration for inter-frequency measurements in accordance with European Telecommunications Standards Institute (ETSI) Technical Specification (TS) 136 133 v12.7.0 (2015-06).

In example 55, the machine readable storage media of any of examples 45 through 54, the operation comprising: schedule a plurality of intra-frequency measurements in accordance with an intra-frequency measurement gap pattern; and schedule a plurality of inter-frequency measurements in accordance with an inter-frequency measurement gap pattern.

In example 56, the machine readable storage media of example 55, wherein the plurality of intra-frequency measurements and the plurality of inter-frequency measurements are portions of an interlaced pattern.

In example 57, the machine readable storage media of example 56, the operation comprising process a transmission from the eNB configuring the interlaced pattern.

In example 58, the machine readable storage media of example 56, the operation comprising establish the interlaced pattern based at least in part upon at least one of: an inter-frequency measurement history, and an inter-frequency measurement history.

Example 59 provides an enhanced Machine Type Communication (eMTC) capable User Equipment (UE) device comprising an application processor, a memory, one or more antennas, a wireless interface for allowing the application processor to communicate with another device, and a touch-screen display, the UE device including an apparatus comprising: one or more processors to: initiate an intra-frequency measurement corresponding with an intra-frequency Measurement Gap Length (MGL) of a first duration; and initiate an inter-frequency measurement corresponding with an inter-frequency MGL of a second duration.

In example 60, the UE device of example 59, wherein the one or more processors are further to: establish the first duration based upon an intra-frequency measurement gap configuration input; and establish the second duration based upon an inter-frequency measurement gap configuration input.

In example 61, the UE device of example 59, wherein the one or more processors are further to: establish the first duration and the second duration are based upon a common measurement gap configuration input.

In example 62, the UE device of any of examples 59 through 61, wherein the one or more processors are further to: retune at least part of a Radio Frequency (RF) chain to a central 6 Physical Resource Blocks (PRBs) of a serving carrier following the initiation of the intra-frequency measurement.

In example 63, the UE device of any of examples 59 through 62, wherein the one or more processors are further to: suspend Uplink (UL) operation during the intra-frequency measurement when an intra-frequency UL suspension enable input is asserted.

In example 64, the UE device of any of examples 59 through 63, wherein the one or more processors are further to: suspend Downlink (DL) operation during the intra-frequency measurement when an intra-frequency DL suspension enable input is asserted.

In example 65, the UE device of any of examples 59 through 64, wherein the one or more processors are further to: suspend UL operation and Downlink (DL) operation during the intra-frequency measurement.

In example 66, the UE device of any of examples 59 through 65, wherein the first duration is shorter than the second duration.

In example 67, the UE device of any of examples 59 through 66, wherein the first duration is approximately 5 milliseconds (ms) and the second duration is approximately 6 ms.

In example 68, the UE device of any of examples 59 through 65, wherein the first duration is approximately the same as the second duration.

In example 69, the UE device of example 68, wherein the first duration and the second duration are approximately the same as an MGL duration for inter-frequency measurements in accordance with European Telecommunications Standards Institute (ETSI) Technical Specification (TS) 136 133 v12.7.0 (2015-06).

In example 70, the UE device of any of examples 59 through 69, wherein the one or more processors are further to: schedule a plurality of intra-frequency measurements in accordance with an intra-frequency measurement gap pattern; and schedule a plurality of inter-frequency measurements in accordance with an inter-frequency measurement gap pattern.

In example 71, the UE device of example 70, wherein the plurality of intra-frequency measurements and the plurality of inter-frequency measurements are portions of an interlaced pattern.

In example 72, the UE device of example 71, wherein the one or more processors are further to: process a transmission from the eNB configuring the interlaced pattern.

In example 73, the UE device of example 71, wherein the one or more processors are further to: establish the interlaced pattern based at least in part upon at least one of: an inter-frequency measurement history, and an inter-frequency measurement history.

Example 74 provides the apparatus of any of examples 1 through 14 and 31 through 44, wherein the one more processors comprise a baseband processor.

Example 75 provides the apparatus of any of examples 1 through 14 and 31 through 44, comprising a transceiver circuitry for generating transmissions and processing transmissions.

An abstract is provided that will allow the reader to ascertain the nature and gist of the technical disclosure. The abstract is submitted with the understanding that it will not be used to limit the scope or meaning of the claims. The following claims are hereby incorporated into the detailed description, with each claim standing on its own as a separate embodiment.

1-20. (canceled)

21. An apparatus of an enhanced Machine Type Communication (eMTC) capable User Equipment (UE) operable to communicate with an eMTC capable Evolved Node-B (eNB) on a wireless network, comprising:
one or more processors to:
initiate an intra-frequency measurement corresponding with an intra-frequency Measurement Gap Length (MGL) of a first duration; and
initiate an inter-frequency measurement corresponding with an inter-frequency MGL of a second duration
retune at least part of a Radio Frequency (RF) chain to a central 6 Physical Resource Blocks (PRBs) of a serving carrier following the initiation of the intra-frequency measurement.

22. The apparatus of claim 21, wherein the one or more processors are further to:
establish the first duration based upon an intra-frequency measurement gap configuration input; and
establish the second duration based upon an inter-frequency measurement gap configuration input.

23. The apparatus of claim 21, wherein the one or more processors are further to:
establish the first duration and the second duration are based upon a common measurement gap configuration input.

24. The apparatus of claim 21, wherein the one or more processors are further to:
suspend Uplink (UL) operation during the intra-frequency measurement when an intra-frequency UL suspension enable input is asserted.

25. The apparatus of claim 21,
wherein the first duration is shorter than the second duration.

26. The apparatus of claim 21,
wherein the first duration is approximately 5 milliseconds (ms) and the second duration is approximately 6 ms.

27. The apparatus of claim 21,
wherein the first duration is approximately the same as the second duration.

28. The apparatus of claim 27,
wherein the first duration and the second duration are approximately the same as an MGL duration for inter-frequency measurements in accordance with European Telecommunications Standards Institute (ETSI) Technical Specification (TS) 136 133 v12.7.0 (2015-06).

29. The apparatus of claim 21, wherein the one or more processors are further to:
schedule a plurality of intra-frequency measurements in accordance with an intra-frequency measurement gap pattern; and
schedule a plurality of inter-frequency measurements in accordance with an inter-frequency measurement gap pattern.

30. The apparatus of claim 29,
wherein the plurality of intra-frequency measurements and the plurality of inter-frequency measurements are portions of an interlaced pattern.

31. The apparatus of claim 30, wherein the one or more processors are further to:
process a transmission from the eNB configuring the interlaced pattern.

32. The apparatus of claim 30, wherein the one or more processors are further to:
establish the interlaced pattern based at least in part upon at least one of: an inter-frequency measurement history, and an inter-frequency measurement history.

33. Machine readable storage media having machine executable instructions that, when executed, cause one or more processors of an enhanced Machine Type Communication (eMTC) capable User Equipment (UE) to perform an operation comprising:
initiate an intra-frequency measurement corresponding with an intra-frequency Measurement Gap Length (MGL) of a first duration;
initiate an inter-frequency measurement corresponding with an inter-frequency MGL of a second duration;
establish the first duration based upon an intra-frequency measurement gap configuration input; and
establish the second duration based upon an inter-frequency measurement gap configuration input.

34. The machine readable storage media of claim 33, the operation comprising:
retune at least part of a Radio Frequency (RF) chain to a central 6 Physical Resource Blocks (PRBs) of a serving carrier following the initiation of the intra-frequency measurement.

35. The machine readable storage media of claim 33,
wherein the first duration is shorter than the second duration.

36. The machine readable storage media of claim 33, the operation comprising:
schedule a plurality of intra-frequency measurements in accordance with an intra-frequency measurement gap pattern; and
schedule a plurality of inter-frequency measurements in accordance with an inter-frequency measurement gap pattern.

37. An enhanced Machine Type Communication (eMTC) capable User Equipment (UE) device comprising an application processor, a memory, one or more antennas, a wireless interface for allowing the application processor to communicate with another device, and a touch-screen display, the UE device including an apparatus comprising:
one or more processors to:
initiate an intra-frequency measurement corresponding with an intra-frequency Measurement Gap Length (MGL) of a first duration; and
initiate an inter-frequency measurement corresponding with an inter-frequency MGL of a second duration.

38. The UE device of claim 37, wherein the one or more processors are further to:
establish the first duration based upon an intra-frequency measurement gap configuration input; and
establish the second duration based upon an inter-frequency measurement gap configuration input.

39. The UE device of claim 37,
wherein the first duration is shorter than the second duration.

40. The UE device of claim 37, wherein the one or more processors are further to:
schedule a plurality of intra-frequency measurements in accordance with an intra-frequency measurement gap pattern; and
schedule a plurality of inter-frequency measurements in accordance with an inter-frequency measurement gap pattern.
